(19) United States
(12) Patent Application Publication
(10) Pub. No.: US 2017/0015133 A1
(43) Pub. Date: Jan. 19, 2017

(54) Paint Holster with Reservoir

(71) Applicant: Carlos Lopez, Hillsboro, OR (US)

(72) Inventor: Carlos Lopez, Hillsboro, OR (US)

(21) Appl. No.: 14/800,984

(22) Filed: Jul. 16, 2015

(51) Int. Cl. B44D 3/24

(52) U.S. Cl. CPC B44D 3/24

(57) ABSTRACT

A manual paint system comprises a holster with cooperatively formed paint reservoir that fixates to the painter's person. The holster is in fluid communication via a valve with a reservoir that holds fresh clean paint. The holster receives a regulated flow of paint when the valve is open. The holster includes a fixator for securing the applicator so that the handle is available for easy grasp while the brush bristles or roller remain wet in paint within the holster. Scrapers within the holster remove excess paint from the applicator and are configured to return the excess paint to the holster for later use. The fixator may be attached to a gate that slideably opens and closes the valve, thereby allowing the painter to load the holster with paint by simply pulling out the applicator and shut off the flow by pushing the applicator back into the holster.

### CROSS-REFERENCE TO RELATED APPLICATIONS

This application claims priority under 35 U.S.C. §119(e)(1) to U.S. Ser. No. 62/031,049 filed Jul. 30, 2014, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### TECHNICAL FIELD

The invention relates to an improved manual paint system, and more particularly to a paint brush or roller holster having a cooperatively formed paint reservoir.

### BACKGROUND ART

The applicable art is replete with paint brush and roller holders, holsters or paint containers which by their construction are meant to be carried by a painter secured at the belt, suspender or harness, designed to keep the handle of an applicator dry and free of debris, with the bristles in the case of a brush, or cover in the case of a roller, wet with paint and ready to use.

Examples of such previous paint applicator holsters include U.S. Pat. No. 5,072,868 filed on Jan. 4, 1991 to Robert Dickie et. al., and U.S. Pat. No. 4,746,042 that issued May 24, 1988, to Richard C. King. The prior art paint brush holders are generally formed by substantially vertical and rectangular front, back, and side panels, either slanted or straight, with an opening at the top to receive, and retain the paint brush. The holder is formed to secure to or about a painters waist area, and holds a small amount of paint for the paint brush bristles to remain in a “paint wet” ready state while not in use.

Another prior art effort to solve the problem of keeping a paint applicator clean and ready with adequate paint reservoir is taught by U.S. Pat. No. 5,261,577 to Goldstein. Goldstein teaches a paint brush caddy adapted to hold a paint brush in association with a paint bucket. The caddy attaches to a paint pail or bucket providing the painter a clean location to place the brush. In the Goldstein configuration, the paint reserve is kept in close proximity to the paint brush, but the open top of the pail is not preferred because contaminates can fall in, and paint is prone to drying out and flaking, making the paint in an open pail susceptible to fouling.

Similar to the caddy device described by Goldstein, Malavasio provides a paint brush holder and wiper unit that attaches to a paint pail as disclosed in U.S. Pat. No. 6,446,829 where the paint flows back in the container from the brush holder. Neither Malavasio nor Goldstein teach a device that does not require the painter to carrier an open top paint pail or bucket.

The prior art devices provide paint applicator holders that keep the paint brush clean and prepared for use in a ‘paint wet’ ready condition, but these devices do not provide a closed paint reservoir that has adequate volume for production type work. The painter still must carry a separate pail or bucket that has an open top up the ladder and must be careful not to let the paint in the pail become fouled or spilled.

There is an unfulfilled need for a man portable device that keeps paint applicators clean and in a “paint wet” ready state for the painter, while providing adequate paint reservoir that is closed from the environment, thereby increasing painter production performance while improving quality.

### SUMMARY OF INVENTION

The present invention provides a paint applicator holster with cooperatively formed paint reservoir that fixates to the painter's person, ideally at the waist. The preferred embodiment includes at holster with space for at least one paint applicator, the holster being in fluid communication via a valve with a paint reservoir having a closeable lid. The holster being configured with at least one compartment to receive an applicator such as a brush or roller. The holster further including internal scrapers that are arranged to remove excess paint while also helping shield and deflect debris from falling into the holster. The valve being in working cooperation with a slideable gate that meters or regulates the paint flow from the reservoir to the holster.

To fill with paint prior to use, the painter slides the gate down to block paint flow from reservoir into the holster, then fills the reservoir. When ready to use, the painter slides up the gate thereby opening the valve which allows paint to controllably flow from the reservoir into the holster. When adequate paint is available in the holster for loading the applicator with paint, the gate is slid down to stop the flow of paint. Any excess paint is removed from the applicator by scrapers that remove excess paint off the applicator while directing the excess paint back into the holster for later use.

One object of the present invention is to improve painter production, specifically reduce the number of trips to refill on paint, which often involves a trip up and down a ladder.

Another object involves keeping the applicator, whether brush or roller, wet with clean paint within the holster at the ready of the painter.

Yet another object includes saving paint, specifically not throwing away dried or dirty paint, the adjustable paint metering gate adjusts the flow of paint from the reservoir to the holster, allowing the painter to set the flow from the reservoir into the holster at the same rate of application, thereby keeping a fresh clean supply of paint to the applicator.

Another object of the present invention is a closed reservoir that prevents accidental paint spillage, prevents contaminates from falling into the paint reserve, and avoids the problem of paint drying within the reservoir when exposed to air.

Another object of the present invention involves the relative volumes of the reservoir verses the holster. The reservoir when full holds no more than twice the volume of the holster. In this way if the user forgets to close the Gate or the paint regulator sticks open, the paint level of the reservoir will equalize with the level in the holster before over filling the holster.

A primary advantage of the present invention is the readily available reserve of clean paint. The painter opens the valve to receive enough paint from the reservoir to perform the current painting task. The reservoir fluid level being maintained higher than that of the holster, thereby providing positive paint flow from the reservoir to the holster. If any contamination falls within the holster, the painter can clear the contamination, and then open the valve to start again with fresh clean paint from the reservoir.

Yet another advantage is the reservoir's ‘fill and close’ feature that provides a significant improvement over the prior art's ‘open top’ vessels for paint, such as a pail or bucket, in that the reservoir has a top the seals out unwanted particulates, while keeping the paint in the reservoir fresh and clean.

Another advantage of the holster involves the scraper features that remove and return excess paint from the applicator back into the holster for reuse. The scrapers further cover the opening of the holster, and keep out dirt and falling debris from polluting the paint within the holster.

Other objects and advantages will become apparent upon reading the following descriptions of drawings in the accompanying figures.

### BRIEF DESCRIPTION OF THE DRAWINGS

FIG. 1 is a top right perspective view of the preferred embodiment of the inventive device configured for use with a brush.

FIG. 2 is a perspective view of the device in FIG. 1 shown in cutaway view.

FIG. 3 is a top down perspective view of the device in FIG. 1.

REFERENCE TABLE

```
  10-Reservoir
  15-Lid
  16-Lid Hinge
  20-Holster
  30-Belt Clip
  40-Applicator
  50-Reservoir Level
  60-Holster Level
  70-Fixator
  80-Gate
  90-Reservoir Level
  95-Holster Level
100-Regulated Flow
110-Valve
130-Scrapers
200-Slide Adjust
```

### DETAILED DESCRIPTION

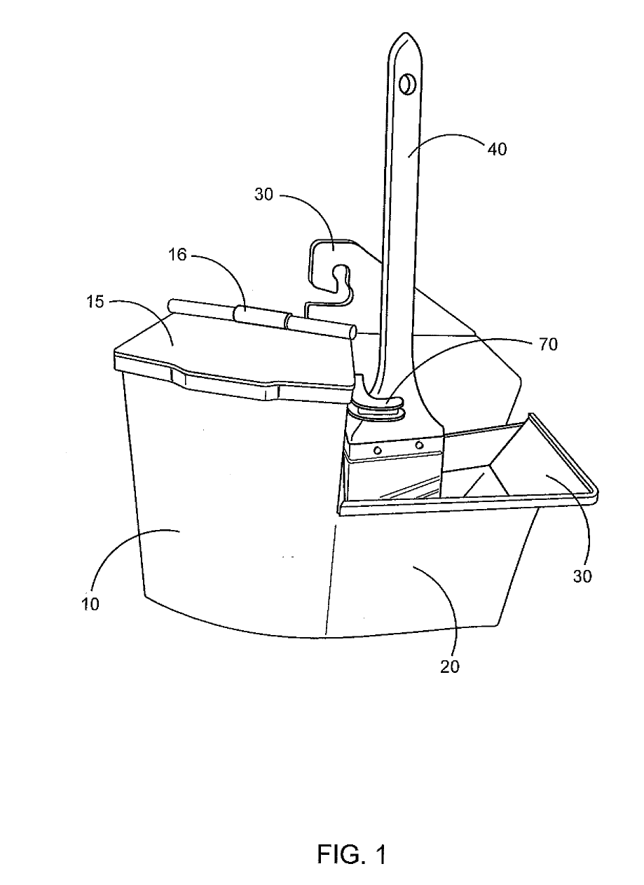

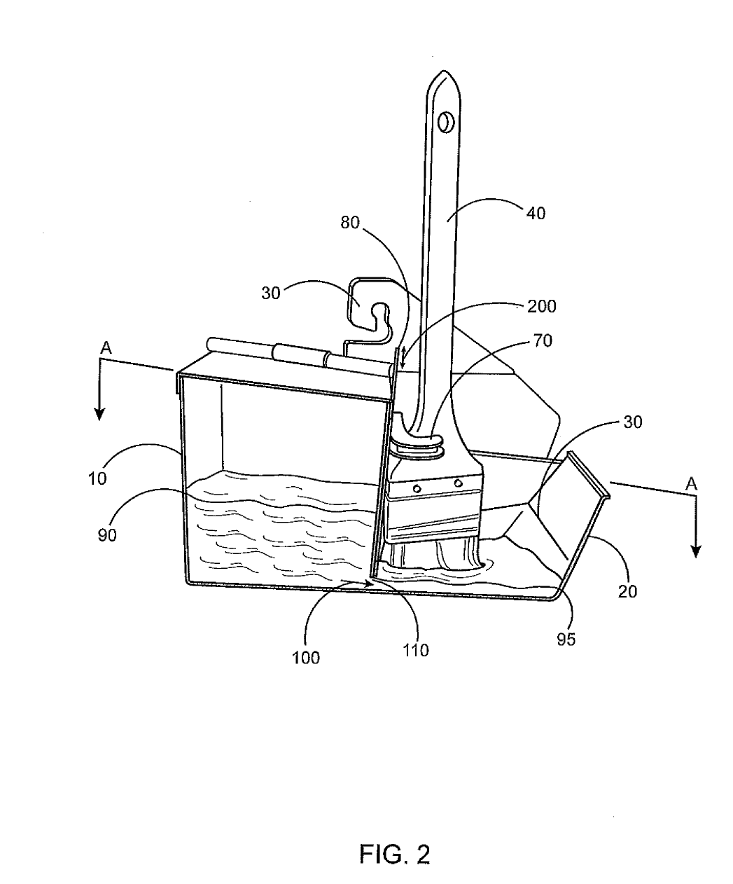

As depicted in FIG. 1-3, the preferred embodiment includes a holster 20 and reservoir 10 cooperatively formed together for easy carry on a painter belt or suspender. The holster 20 being configured to receive a paint applicator 40 such as a brush as depicted, the applicator 40 also could be a roller, sponge, or other manual paint device. The reservoir 10 being in fluid paint communication 100 with the holster 10 via a valve 110 depicted in FIG. 2 as located at or close to the bottom of the reservoir 10. The reservoir 10 being volumetrically limited to half of the maximum volume of the holster 20 such that if the valve 110 is inadvertently left open when the reservoir 10 is full, the paint in the reservoir 10 could not overflow the holster 20. The reservoir 10 further having a closeable lid 15 that keeps paint within the reservoir 10 clean and fresh. The lid 15 pivots about an axis defined by the lid hinge 16 that is located on the side closest to the painter. In this way when the lid 15 is open to receive paint, any spillage, splash, or overfill is directed away from the painter or deflected back into the reservoir.

As shown in FIG. 2, the reservoir level 90 is higher than the holster level 95 which ensures that the regulated flow 100 of paint from the reservoir 10 to the holster 20 is one way thereby preventing any debris in the holster 20 from contaminating the reservoir 10. In practice, as paint in the holster 20 is used up, the painter need only pull up on the gate 80 to replenish. Unlike a pail or bucket that if contaminated the entire container of paint is wasted, the holster 20 is dumped and cleaned only wasting a small amount of paint, and the gate 80 lifted to replenish with fresh clean paint from the reservoir 10.

As shown in FIG. 1 and FIG. 2, a belt hook or clip 30 attaches the inventive device to the hip of the painter, allowing easy carrying up scaffolding and ladders while keeping the opening of the holster 20 oriented up to prevent spilling. At least one scraper 130 is located within the holster 20 so that when excess paint from the applicator 40 is scraped off, the excess paint is returned to the holster 20 for later use. The scraper(s) 130

[symbol]

The elements of FIG. 1 are depicted in FIG. 2 by a cutaway view as indicated by the sectional arrows A. As shown and depicted the valve 110 provides regulated flow 100 from the reservoir 10 into the holster 20 when the painter slide adjusts 200 the gate 80 up or down. The gate 80 sets and adjusts the flow rate from the reservoir 10 through the valve 110 to the holster 20. The preferable rate of regulated flow 100 from the reservoir 10 into the holster 20 ideally matches the paint usage as applied by the painter. In use, the painter slide adjusts 200 to control the regulated flow 100 rate through the valve 110 by sliding the gate 80 up for more paint, down for less, or all the way down to shut off. As depicted the gate 80 slides up and down relative to the holster 20, however in other embodiments the gate 80 is rotated to slide adjust 200 the paint flow through the valve 110.

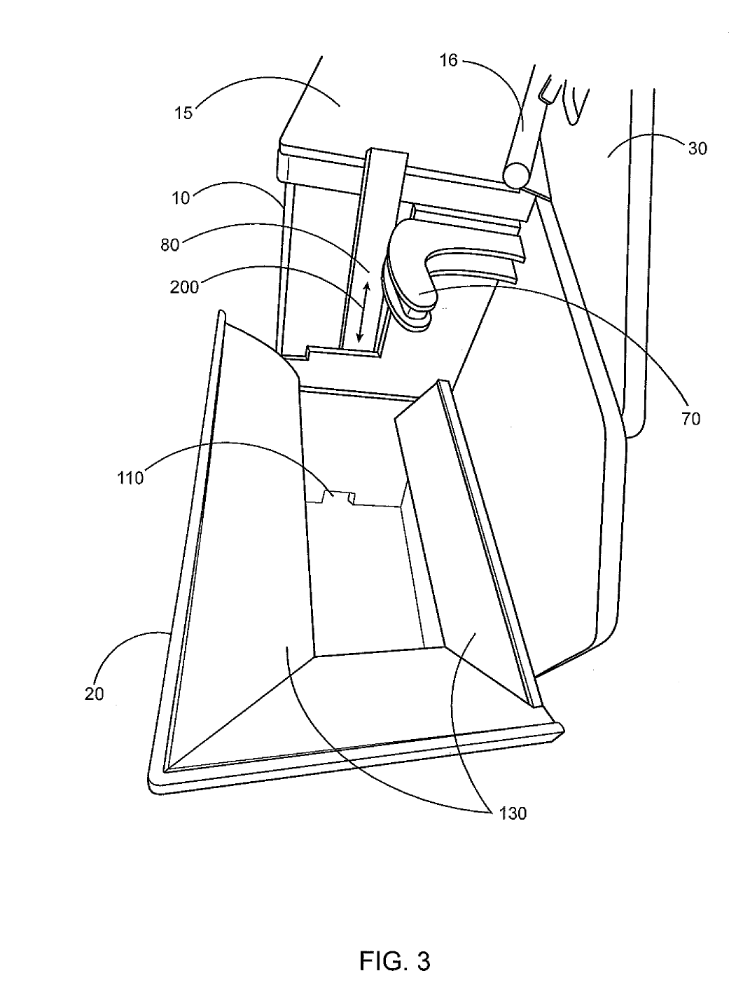

As shown in FIG. 2 and FIG. 3 the applicator fixator 70 is attached to the reservoir 10. However, for certain painting applications it is desirable to have the applicator 40 connected to the gate 80 via fixator 70 to enable the painter one handed slide adjust 200 by pulling the applicator 40 out, or pushing it in the holster 20 as held by the fixator 70. The fixator 70 being either attached to the gate 80 or integrally formed with the gate 80, the painter opens the valve 110 when the applicator 40 is pulled out for use, and when the applicator 40 is returned to the fixator 70, the gate 80 is pushed down to stop the paint flow when not in use.

As shown in FIG. 1 and FIG. 2, and as depicted in FIG. 3, the applicator 40 is kept such that the handle is vertically disposed by the fixator 70 allowing for convenient grasp for use, similar to a pistol holster. When held in the holster 20, the applicator 40 is maintained in a “clean” and “paint wet” condition under the scrapers 130. The scrapers 130 protect the paint in the holster 20 from falling debris, while also providing the utilitarian function of removing excess paint when the user pulls the applicator 40 from the holster 20 for use. In the case of a brush applicator 40, the removal movement removes excess paint. Similarly for the roller applicator 40, any resulting removed excess paint from the applicator 40 is kept clean, and re-deposited into the holster 20 for later use. The wipers 130 are shaped and formed to scrape excess paint back into the holster 20 while shielding or protecting the applicator 40 and holster 20 opening from contamination. The scrapers 130 can be solidly formed as shown, bristled like a broom, or constructed in any other suitable physical construct or material that can wipe off excess paint, while deflecting debris away from the holster's 20 open top, and applicator 40 therein.

The holster 20 shown in FIGS. 1-3 can include more than one paint chamber, and may include compartments to hold more than one type of applicator 40. Additional compartments within the holster 20 may either collectively receive paint from the reservoir 10 by one valve 110, or discretely through a plurality of valves 110. Showing additional compartments that perform the same function in the same way as the described single holster 20 compartment will not be repetitively described herein for purposes of clarity and brevity.

While the foregoing description and drawings represent the preferred embodiment of the present invention, it is to be understood that various additions, modifications and substitutions may be made therein without departing from the spirit and scope of the principles of the disclosed invention as defined in the accompanying claims. The materials suitable for constructing the preferred embodiment include but are not limited to plastic, aluminum, or a combination thereof. One skilled in the art will appreciate that the invention may be adapted with many modifications of form, structure, arrangement, proportions, materials, elements, and components and otherwise, used in the practice of the invention, which are particularly adapted to specific painting environments and job requirements without departing from the principles of the present invention. The presently disclosed embodiment is therefore to be considered in all respects as illustrative and not restrictive, the scope of the invention being indicated by the appended claims and their legal equivalents, and not limited to the foregoing description.

What is claimed is:

1. A manual paint system with attached reservoir, comprising:
a reservoir in fluid communication with a holster via a valve;
the holster having internal space to receive an applicator; and
the valve having a gate that slideably adjusts the valve opening size thereby regulating paint flow from the reservoir to the holster.

2. A manual paint system with attached reservoir, comprising:
a reservoir in fluid communication with a holster via a valve;
the reservoir having a paint capacity of no more than twice that of the holster paint capacity;
the holster having internal space to receive an applicator; and
the valve being adjustable to regulate paint flow from the reservoir to the holster.

3. A manual paint system with attached reservoir, comprising:
a reservoir in fluid communication with a holster via a valve;
the holster having internal space for receiving an applicator, the holster further including internal scrapers that remove excess paint off of an applicator when the applicator is withdrawn from the holster, such that the excess paint is gravity returned to the holster for later use; and
the valve being adjustable to regulate paint flow from the reservoir to the holster.

2. The paint system in accordance with claims 1, 2 and 3, in which the applicator is a brush.

3. The paint system in accordance with claims 1, 2 and 3, in which the applicator is a roller.

4. The paint system in accordance with claims 1, 2 and 3, in which the holster includes at least one hook or clip for attaching the holster and reservoir to the belt of a painter.

5. The paint system in accordance with claims 1, 2 and 3, in which the holster includes at least one fixator for retaining the applicator in the holster when not in use.

6. The paint system in accordance with claims 1, 2 and 3, in which the holster includes at least two separate compartments.

7. The paint system in accordance with claims 1, 2 and 3, in which the holster includes at least two separate compartments that receive paint from the reservoir through at least two valves.

8. The paint system in accordance with claims 1, 2 and 3, in which the reservoir includes a closeable lid.

9. The paint system in accordance with claims 1, 2 and 3, in which the reservoir includes a sealed top.

10. The paint system in accordance with claims 1, 2 and 3, in which the holster includes at least two valves that are in flow communication with the reservoir.

11. The paint system in accordance with claims 1, 2 and 3, in which the reservoir and holster are integrally formed.

12. The paint system in accordance with claims 1, 2 and 3, in which the valve is located at the bottom of the reservoir.

13. The paint system in accordance with claims 1, 2 and 3, in which the valve is located at the bottom of the holster.

14. The paint system in accordance with claim 1, in which the holster includes at least one fixator for retaining the applicator, the fixator being attached to the gate such that when the applicator is pulled up the gate slideably opens the valve.

15. The paint system in accordance with claims 1 and 2, in which the holster further includes internal scrapers that remove excess paint off of an applicator when the applicator is withdrawn from the holster, such that the excess paint is gravity returned to the holster for later use.

16. The paint system in accordance with claim 1, in which the gate slideably adjusts the flow of paint through the valve by sliding up and down.

17. The paint system in accordance with claim 1, in which the gate slideably adjusts the flow of paint through the valve by rotating.

18. The paint system in accordance with claim 3, in which the internal scrapers are constructed and arranged to scrape excess paint and deflect debris or contaminates from entering the holster.
